(19) United States
(12) Patent Application Publication
(10) Pub. No.: US 2025/0225267 A1
(43) Pub. Date: Jul. 10, 2025

(54) DATA SCRAMBLE SYSTEM AND DATA SCRAMBLE METHOD

(71) Applicant: REALTEK SEMICONDUCTOR CORPORATION, HSINCHU (TW)

(72) Inventor: Kai-Hsiang Chou, Hsinchu (TW)

(21) Appl. No.: 19/007,623

(22) Filed: Jan. 2, 2025

(30) Foreign Application Priority Data
Jan. 5, 2024 (TW) 113100670

(51) Int. Cl. G06F 21/62; H04L 61/30

(52) U.S. Cl. CPC G06F 21/6218; H04L 61/30

(57) ABSTRACT

A data scramble system includes a scramble device, an network address generator, and a balance maker. The scramble device changes at least one target word of an input data into at least one predetermined word for generating an output data, and transmit the output data to an artificial intelligence website. The network address generator generates network addresses. The balance maker inserts at least one error into at least one target code of the input data or modifies the at least one target code of the input data for generating related data. The balance maker transmits a first related data and a second related data of the related data to the artificial intelligence website through a first network address and a second network address of the network addresses. The first network address is related to the input data, and the second network address is not related to the input data.

### BACKGROUND OF THE INVENTION

### 1. Field of the Invention

The present disclosure relates to a data scramble system and a data scramble method, especially to a data scramble system and a data scramble method that can utilize a scramble device and a balance maker to work together for executing a data scramble operation and counteracting an automatic learning mechanism of an artificial intelligence website.

### 2. Description of Related Art

With the progress of technology, artificial intelligence websites can assist in answering questions of users, such that users can obtain answers quickly and accurately. However, if users ask about confidential information from external artificial intelligence websites, it may result in the leakage of confidential information. If users create artificial intelligence websites on their own, it not only consumes considerable time but also involves extremely high costs.

### SUMMARY OF THE INVENTION

In some aspects, an object of the present disclosure is to, but not limited to, provides a data scramble system and a data scramble method that makes an improvement to the prior art.

An embodiment of a data scramble system of the present disclosure includes a scramble device, a network address generator, and a balance maker. The scramble device is configured to change at least one target word of an input data into at least one predetermined word for generating an output data, and transmit the output data to an artificial intelligence website. The network address generator is configured to generate a plurality of network addresses. The balance maker is configured to randomly insert at least one error into at least one target code of the input data or configured to modify the at least one target code of the input data for generating a plurality of related data, wherein the balance maker transmits a first related data and a second related data of the related data to the artificial intelligence website through a first network address and a second network address of the network addresses respectively, wherein the first related data is related to the input data, and the second related data is not related to the input data.

An embodiment of a data scramble method of the present disclosure includes: changing at least one target word of an input data into at least one predetermined word for generating an output data, and transmitting the output data to an artificial intelligence website by a scramble device; generating a plurality of network addresses by a network address generator; randomly inserting at least one error into at least one target code of the input data or modifying the at least one target code of the input data for generating a plurality of related data by a balance maker; and transmitting a first related data and a second related data of the related data to the artificial intelligence website through a first network address and a second network address of the network addresses respectively by the balance maker, wherein the first related data is related to the input data, and the second related data is not related to the input data.

Technical features of some embodiments of the present disclosure make an improvement to the prior art. The data scramble system and the data scramble method of the present disclosure can utilize the scramble device and the balance maker to work together for executing a data scramble operation, thereby resolving the situation where confidential information may be leaked due to external inquiries from the artificial intelligence website. Furthermore, since the data scramble system and the data scramble method of the present disclosure can efficiently prevent the leakage of confidential information, users do not need to create artificial intelligence websites on their own to prevent the leakage of confidential information. Therefore, the present disclosure not only saves time in creating artificial intelligence websites but also saves extremely high costs associated with creating artificial intelligence websites.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a data scramble system of the present disclosure.

FIG. 2 shows an embodiment of a flow diagram of a data scramble method of the present disclosure.

### DETAILED DESCRIPTION OF THE PREFERRED EMBODIMENTS

For improving problems of users inquiring about confidential information from external artificial intelligence websites that may result in the leakage of confidential information, the present disclosure provides a data scramble system and a data scramble method, which will be explained in detail as below.

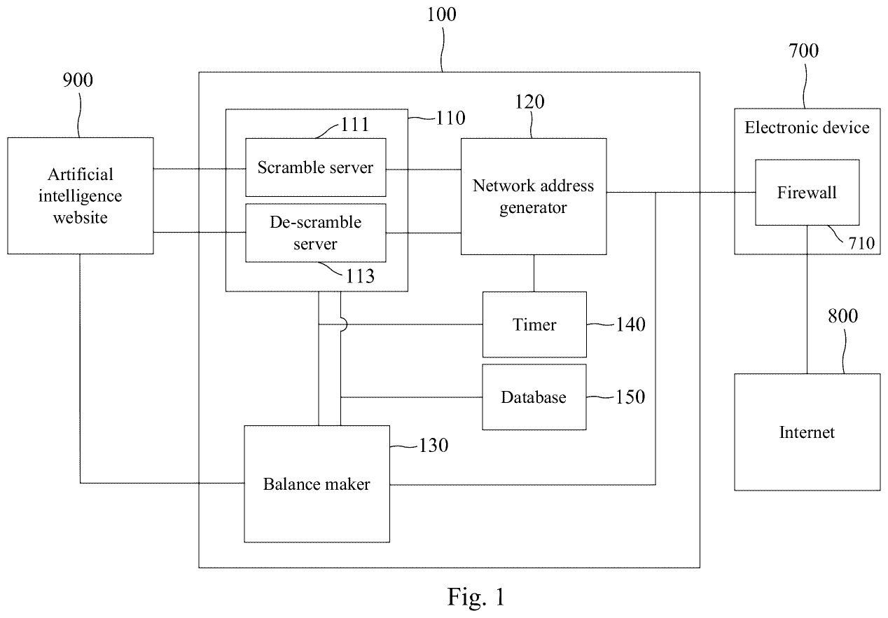

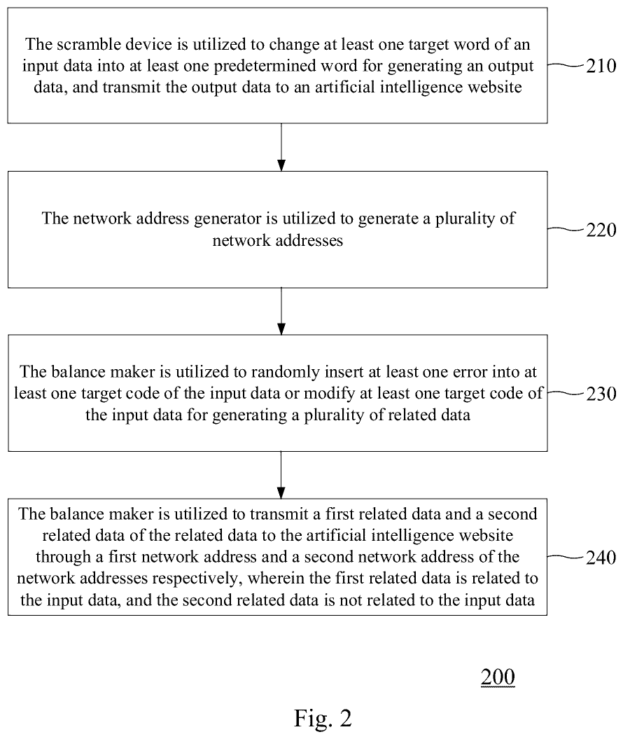

FIG. 1 shows an embodiment of a data scramble system 100 of the present disclosure. As shown in the figure, the data scramble system 100 includes a scramble device 110, a network address generator 120, and a balance maker 130. For facilitating the understanding of the operations of the data scramble system 100, reference is now made to FIG. 2. FIG. 2 shows an embodiment of a flow diagram of a data scramble method 200 of the present disclosure.

Referring to FIG. 1 and FIG. 2, in step 210, the scramble device 110 is utilized to change at least one target word of an input data into at least one predetermined word for generating an output data, and transmit the output data to an artificial intelligence website.

For example, when users want to ask about questions from the artificial intelligence website 900, users can input questions through the electronic device 700. To prevent the leakage of confidential information, the firewall 710 of the electronic device 700 can store multiple Internet Protocol (IP) addresses of different artificial intelligence websites 900, such as storing the IP address of the Chat Generative Pre-trained Transformer (ChatGPT). Once the firewall 710 detects that the electronic device 700 intends to connect to the artificial intelligence website 900, the firewall 710 will direct the questions from the electronic device 700 to the data scramble system 100. On the contrary, the firewall 710 will direct the questions from the electronic device 700 to the Internet 800.

Subsequently, when the scramble device 110 receives the question from the electronic device 700, the scramble device 110 can change target words (e.g., Company A) of the question to predetermined words (e.g., Company B) to generate a modified question, and transmit the modified question to the artificial intelligence website 900. In this way, the present disclosure can change confidential information (e.g., Company A) into other information to solve problems of users asking about confidential information from external artificial intelligence website 900 resulting in the leakage of confidential information. It is noted that the present disclosure is not limited to the above-mentioned embodiment, and users can change different keywords (e.g., specific model numbers, customer names, and so on) into other words based on actual requirements.

In some embodiments, the scramble device 110 includes a de-scramble server 113. The de-scramble server 113 is configured to receive a response data corresponding to the output data from the artificial intelligence website 900, and restore the at least one predetermined word of the response data to be the at least one target word for generating a result data. For example, the de-scramble server 113 receives responses to the questions from the artificial intelligence website 900, and restores the predetermined word (e.g., Company B) in the responses to be the target word (e.g., Company A) to generate a real result for user's reference.

In some embodiments, the data scramble system 100 further includes a timer 140. The timer 140 provides a predetermined time. The scramble device 110 further includes a scramble server 111. The scramble server 111 is configured to transmit the output data to the artificial intelligence website 900 at a first time point, and the de-scramble server 113 receives the response data from the artificial intelligence website 900 at a second time point. For example, the predetermined time provided by the timer 140 is 60 seconds. The scramble server 111 sends a question to the artificial intelligence website 900 at 9:00:00 AM, and the de-scramble server 113 receives a response from the artificial intelligence website 900 at 9:00:59 AM. The time difference between the two events is 59 seconds, and the time difference is lower than the predetermined time of 60 seconds. Therefore, the de-scramble server 113 restores the predetermined word (e.g., Company B) in the response to be the target word (e.g., Company A) to generate a real result for user's reference.

In some embodiments, if the time difference between the first time point and the second time point is larger than the predetermined time, the de-scramble server 113 does not execute a de-scramble operation to the response data. For example, as described in the above-mentioned embodiments, the predetermined time provided by the timer 140 is 60 seconds. The scramble server 111 sends a question to the artificial intelligence website 900 at 9:00:00 AM, and the de-scramble server 113 receives the response from the artificial intelligence website 900 at 9:01:15 AM. The time difference between the two is 1 minute and 15 seconds, and the time difference is larger than the predetermined time of 60 seconds. Therefore, the de-scramble server 113 does not execute a de-scramble operation to the response for obtaining the result.

In step 220, the network address generator 120 is utilized to generate a plurality of network addresses.

For example, the network address generator 120 can generate a plurality of Internet Protocol (IP) addresses. When the scramble device 110 receives a question from the electronic device 700, the scramble device 110 can change the target word (e.g., Company A) of the question into a predetermined word (e.g., Company B), change the Internet Protocol (IP) address, and transmit the modified question to the artificial intelligence website 900. In this way, the present disclosure not only confuses the real content of the question but also obfuscates the Internet Protocol (IP) address that raised the question, such that problems of users inquiring about confidential information from external artificial intelligence website 900 that may result in the leakage of confidential information can be solved, and leakage of information of the questioner asking the confidential information can be avoided.

In step 230, the balance maker 130 is utilized to randomly insert at least one error into at least one target code of the input data or modify at least one target code of the input data for generating a plurality of related data. For example, the balance maker 130 randomly inserts an error into the target code of the question or change the target code of the question for generating a plurality of modified codes. After receiving a response from the artificial intelligence website 900, it proceeds to remove any randomly inserted error and restore the modified target code for generating real results for user's reference.

In step 240, the balance maker 130 is utilized to transmit a first related data and a second related data of the related data to the artificial intelligence website through a first network address and a second network address of the network addresses respectively. The first related data is related to the input data, and the second related data is not related to the input data. For example, to counteract an automatic learning mechanism of the artificial intelligence website 900, the balance maker 130 can generate multiple sets of similar questions, and ack questions to the artificial intelligence website 900 through different IP addresses and time points for counteracting the automatic learning mechanism of the artificial intelligence website 900.

In some embodiments, the balance maker 130 receives a first response data corresponding to the first related data from the artificial intelligence website 900, receives a second response data corresponding to the second related data from the artificial intelligence website 900, and generates a result data according to the first response data corresponding to the first related data. For example, as described in the above-mentioned embodiments, among multiple sets of similar questions, at least one set of similar questions is related to the real question, while the remaining similar questions are unrelated to the real question. The presentation of the remaining similar questions is only for the purpose of counteracting the automatic learning mechanism of the artificial intelligence website 900. Therefore, even if the balance maker 130 receives responses to all similar questions from the artificial intelligence website 900, the balance maker 130 will only generate inquiry results according to the real question for user's reference.

In some embodiments, the balance maker 130 further transmits the related data to the artificial intelligence website 900 through the network addresses, and a number of the related data transmitted by the balance maker 130 is less than a predetermined threshold. For example, if the balance maker 130 generates an excessive number of questions to the artificial intelligence website 900, it may be deemed by the artificial intelligence website 900 as a malicious hacking attempt, leading to being blocked by the artificial intelligence website 900. Therefore, the present disclosure will set a predetermined threshold to restrict the number of questions generated by the balance maker 130 to prevent it from being blocked by the artificial intelligence website 900. In some embodiments, the predetermined threshold can be set at 100 times. However, the present disclosure is not limited to the above-mentioned embodiment, and users can set the predetermined threshold to be 10 times or 1000 times based on different conditions or actual requirements.

In some embodiments, the data scramble system 100 further includes a database 150. The database 150 is configured to provide the at least one predetermined word corresponding to the at least one target word. For example, the database 150 stores the predetermined word (e.g., Company B). When the scramble device 110 receives a question from the electronic device 700, the scramble device 110 can change the target word (e.g., Company A) of the question into the predetermined word (e.g., Company B) stored in the database 150 to generate a modified question.

In some embodiments, a number of the at least one predetermined word is plural. The database 150 provides one of the predetermined words corresponding to the at least one target word based on different time points. For example, the predetermined word provided by the database 150 may vary over time. For instance, at 9:00:00 AM, the predetermined word provided by the database 150 is Company B. When the scramble device 110 receives a question from the electronic device 700, the scramble device 110 can change the target word (e.g., Company A) in the question into the predetermined word (e.g., Company B) provided by the database 150 to generate a modified question.

In addition, at 9:01:15 AM, the predetermined word provided by the database 150 is changed to Company C. When the scramble device 110 receives a question from the electronic device 700, the scramble device 110 can change the target word (e.g., Company A) of the question into the predetermined word (e.g., Company C) provided by the database 150 for generating a modified question. Subsequently, the modified question is sent to the artificial intelligence website 900. After receiving a response from the artificial intelligence website 900, the predetermined word (e.g., Company B or Company C) is then restored to be the target word (e.g., Company A). The present disclosure can dynamically change keywords over time, for example, Company A may be changed to Company B or Company C at different time points, and only the present disclosure knows the specific word to which the keyword has been changed. In this way, the risk of confidential information leakage can be further reduced.

In some embodiments, the scramble device 110 further changes a target model of the input data into a predetermined model. For example, when the scramble device 110 executes a scramble operation to Log files, the present disclosure can change the model to other models to avoid the leakage of confidential information.

In some embodiments, the scramble device 110 further changes a target image of the input data into a predetermined image. For example, the scramble device 110 can change the trademark image of Company A into the trademark image of Company B to prevent the leakage of confidential information. It is noted that the present disclosure is not limited to the above-mentioned embodiment, and the scramble device 110 can change different images (e.g., portrait, building image, and so on) into other images based on actual requirements.

It is noted that the present disclosure is not limited to the embodiments as shown in FIG. 1 to FIG. 2, it is merely an example for illustrating one of the implements of the present disclosure, and the scope of the present disclosure shall be defined on the bases of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The data scramble system 100 and the data scramble method 200 of the present disclosure can utilize the scramble device 110 and the balance maker 130 to work together for executing a data scramble operation, thereby resolving the situation where confidential information may be leaked due to external inquiries from the artificial intelligence website 900. Furthermore, since the data scramble system 100 and the data scramble method 200 of the present disclosure can efficiently prevent the leakage of confidential information, users do not need to create artificial intelligence websites on their own to prevent the leakage of confidential information. Therefore, the present disclosure not only saves time in creating artificial intelligence websites but also saves extremely high costs associated with creating artificial intelligence websites.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A data scramble system, comprising:
a scramble device, configured to change at least one target word of an input data into at least one predetermined word for generating an output data, and transmit the output data to an artificial intelligence website;
an network address generator, configured to generate a plurality of network addresses; and
a balance maker, configured to randomly insert at least one error into at least one target code of the input data or configured to modify the at least one target code of the input data for generating a plurality of related data, wherein the balance maker transmits a first related data and a second related data of the related data to the artificial intelligence website through a first network address and a second network address of the network addresses respectively, wherein the first related data is related to the input data, and the second related data is not related to the input data.

2. The data scramble system of claim 1, wherein the scramble device comprises:
a de-scramble server, configured to receive a response data corresponding to the output data from the artificial intelligence website, and restore the at least one predetermined word of the response data to be the at least one target word for generating a result data.

3. The data scramble system of claim 2, further comprising:
a timer, configured to provide a predetermined time;
wherein the scramble device further comprises:
a scramble server, configured to transmit the output data to the artificial intelligence website at a first time point, and the de-scramble server receives the response data from the artificial intelligence website at a second time point,
wherein if a time difference between the first time point and the second time point is less than or equal to the predetermined time, the de-scramble server restores the at least one predetermined word of the response data to be the at least one target word for generating the result data.

4. The data scramble system of claim 3, wherein if the time difference between the first time point and the second time point is larger than the predetermined time, the de-scramble server does not execute a de-scramble operation to the response data.

5. The data scramble system of claim 1, wherein the balance maker receives a first response data corresponding to the first related data from the artificial intelligence website, receives a second response data corresponding to the second related data from the artificial intelligence website, and generates a result data according to the first response data corresponding to the first related data.

6. The data scramble system of claim 1, wherein the balance maker further transmits the related data to the artificial intelligence website through the network addresses, wherein a number of the related data transmitted by the balance maker is less than a predetermined threshold.

7. The data scramble system of claim 1, further comprising:
a database, configured to provide the at least one predetermined word corresponding to the at least one target word.

8. The data scramble system of claim 7, wherein the number of the at least one predetermined word is plural, wherein the database provides one of the predetermined words corresponding to the at least one target word based on different time points.

9. The data scramble system of claim 1, wherein the scramble device further changes a target model of the input data into a predetermined model.

10. The data scramble system of claim 1, wherein the scramble device further changes a target image of the input data into a predetermined image.

11. A data scramble method, comprising:
changing at least one target word of an input data into at least one predetermined word for generating an output data, and transmitting the output data to an artificial intelligence website by a scramble device;
generating a plurality of network addresses by a network address generator;
randomly inserting at least one error into at least one target code of the input data or modifying the at least one target code of the input data for generating a plurality of related data by a balance maker; and
transmitting a first related data and a second related data of the related data to the artificial intelligence website through a first network address and a second network address of the network addresses respectively by the balance maker, wherein the first related data is related to the input data, and the second related data is not related to the input data.

12. The data scramble method of claim 11, further comprising:
receiving a response data corresponding to the output data from the artificial intelligence website, and restoring the at least one predetermined word of the response data to be the at least one target word for generating a result data by a de-scramble server.

13. The data scramble method of claim 12, further comprising:
providing a predetermined time by a timer;
transmitting the output data to the artificial intelligence website at a first time point by a scramble server of the scramble device;
receiving the response data from the artificial intelligence website at a second time point by the de-scramble server;
if a time difference between the first time point and the second time point is less than or equal to the predetermined time, the de-scramble server restores the at least one predetermined word of the response data to be the at least one target word for generating the result data.

14. The data scramble method of claim 13, further comprising:
if the time difference between the first time point and the second time point is larger than the predetermined time, the de-scramble server does not execute a de-scramble operation to the response data.

15. The data scramble method of claim 11, further comprising:
receiving a first response data corresponding to the first related data from the artificial intelligence website by the balance maker;
receiving a second response data corresponding to the second related data from the artificial intelligence website by the balance maker; and
generating a result data according to the first response data corresponding to the first related data by the balance maker.

16. The data scramble method of claim 11, wherein transmitting the first related data and the second related data of the related data to the artificial intelligence website through the first network address and the second network address of the network addresses respectively by the balance maker comprises:
transmitting the related data to the artificial intelligence website through the network addresses by the balance maker, wherein a number of the related data transmitted by the balance maker is less than a predetermined threshold.

17. The data scramble method of claim 11, further comprising:
providing the at least one predetermined word corresponding to the at least one target word by a database.

18. The data scramble method of claim 17, wherein the number of the at least one predetermined word is plural, wherein providing the at least one predetermined word corresponding to the at least one target word by the database comprises:
providing one of the predetermined words corresponding to the at least one target word based on different time points by the database.

19. The data scramble method of claim 11, further comprising:
changing a target model of the input data into a predetermined model by the scramble device.

20. The data scramble method of claim 11, further comprising:
changing a target image of the input data into a predetermined image by the scramble device.
